(19) United States
(12) Patent Application Publication
(10) Pub. No.: US 2022/0113455 A1
(43) Pub. Date: Apr. 14, 2022

(54) DECORATIVE CLEAR OR TRANSLUCENT PANEL, TRIM, OR LENS WITH TEXTURE ON OPPOSITE SIDES

(71) Applicant: Lacks Enterprises, Inc., Grand Rapids, MI (US)

(72) Inventor: Thomas HAWKINS, Grand Rapids, MI (US)

(21) Appl. No.: 17/500,382

(22) Filed: Oct. 13, 2021

Related U.S. Application Data
(60) Provisional application No. 63/090,979, filed on Oct. 13, 2020.

(51) Int. Cl. G02B 3/02; B60R 13/00

(52) U.S. Cl. CPC G02B 3/02; G02B 2003/0093; B60R 13/00

(57) ABSTRACT

A decorative component includes a body having opposing first and second surfaces. A microtexture is defined on both the first surface and the second surface. The microtexture may be in the form of positive or negative protrusions that extend from the surface of the body or into the surface of the body. The combination of protrusions on the first and second surfaces of the body creates a graphical representation with improved depth and detail. The pattern of the microtexture on the first side and the second side may be the same or different, and may include different sized protrusions and spacing to achieve the desired graphical effect. The body may be attached to a reflective panel, and may further include a light source for illuminating the decorative component. Additional features may be printed on the body in addition to the graphical representation defined by the microtexture.

### CROSS-REFERENCE TO RELATED APPLICATIONS

The present application claims the benefit of previously filed U.S. Provisional Patent Application No. 63/090,979, filed Oct. 13, 2020, the entire content of which is hereby incorporated by reference in its entirety.

### FIELD OF THE DISCLOSURE

The present disclosure is directed to decorative components. More particularly, the present disclosure is directed to a decorative clear or translucent panel, trim, or lens for products in the automotive, appliance, and consumer electronics industries.

### BACKGROUND OF THE DISCLOSURE

Decorative components, such as a decorative component disposed on automotive products in one example, are typically used to add an aesthetic feature to appeal to a variety of tastes of variety of potential consumers. Consumer decisions on whether to buy one particular product relative to another can be substantially affected by appearance, especially in cases of similarly functioning products.

One type of decorative component is a chrome-plated decorative component, which may be in the form of a molded part having a decorative chrome finish applied thereto. Such types of decorative components have been used for vehicle grilles, external vehicle trim, and internal vehicle trim, among other examples.

However, decorative component manufacturing processes and consumer taste have changed over time, and therefore the desire for more complicated decorative parts and designs has evolved and increased. For example, it has become desirable to incorporate multiple functions into a single part or component, such that aesthetic features can be added to the manufacturing of a component with fewer manufacturing steps.

Example of decorative components for a vehicle include grilles, wheel covers, claddings, interior decorative pieces, and the like. These types of decorative components or assemblies present a visible aesthetic surface to the driver, passenger, or observer of the vehicle. However, it is desirable to increase the available design aspects for these components to allow designers and manufacturers more freedom in creating a variety of decorative features.

### SUMMARY

According to an aspect of the disclosure, a decorative component for use with an automotive vehicle is provided, including: a lens body defining a first surface and a second surface, wherein the first surface and the second surface are disposed on opposite sides of the lens body; a plurality of first protrusions disposed on the first surface; a plurality of second protrusions disposed on the second surface; wherein the first and second protrusions define a first and second microtexture on the first and second surface, respectively; wherein the first and second microtextures combine to define a graphical representation on the lens having an enhanced depth and blending of the microtextures.

In one aspect, the first protrusions are arranged in a first pattern on the first surface and the second protrusions are arranged in a second pattern on the first surface.

In one aspect, the first and second pattern are the same pattern.

In one aspect, the first protrusions are spaced apart a first distance and the second protrusions are spaced apart a second distance.

In one aspect, the first distance is less than the second distance.

In one aspect, the first and second pattern are different.

In one aspect, the first protrusions are positive and the second protrusions are negative.

In one aspect, at least one of the first protrusions overlies at least one of the second protrusions.

In one aspect, at least one of the first pattern and the second pattern are spaced in a gradient manner.

In one aspect, each of the first protrusions are the same size and shape, and each of the second protrusions are the same size and shape.

In one aspect, some of the first protrusions are positive and some of the first protrusions are negative.

In one aspect, the lens is a single piece, and the first and second surfaces are defined on the single piece.

In one aspect, the decorative component includes a reflective panel disposed adjacent the second surface of the lens.

In one aspect, the decorative component includes a light source disposed between the lens body and the reflective panel.

In one aspect, the first protrusions are positive and project outwardly from the lens body, and wherein the second protrusions are negative and are defined by cavities extending into the second surface.

In one aspect, the decorative component includes a printed feature disposed on the lens body in addition to the microtexture.

In one aspect, the first protrusions and the second protrusions are aligned.

In one aspect, the first protrusions and the second protrusions are misaligned.

In one aspect, the second protrusions are larger than the first protrusions.

In one aspect, the lens body includes a first piece and second piece, wherein the first surface and first protrusions are disposed on the first piece, and the second surface and the second protrusions are disposed on the second piece, wherein the first piece is attached to the second piece.

In another aspect, a decorative component for use in an automotive application includes: a clear or translucent body portion having a first surface and a second surface; a first microtexture disposed on the first surface; a second microtexture disposed on the second surface; wherein the first and second microtextures combine to define a graphical representation having an enhanced depth and blending of the microtextures. In one aspect, the body portion may be colored or tinted.

In one aspect, the decorative component also includes a light source disposed adjacent the body portion for transmitting light through the body portion and illuminating the microtextures, and a reflective surface disposed adjacent the second surface, wherein the reflective surface reflects ambient light or light provided by a light source through the lens body and the first and second microtextures.

In yet another aspect, a decorative component for an automotive vehicle includes: a clear or translucent body portion having a top surface and a bottom surface; a top microtexture disposed on the top surface; a bottom microtexture disposed on the bottom surface; wherein light passing through the body portion reflects off the top and bottom microtextures and defines a graphical representation. In one aspect, the body portion may be colored or tinted.

In one aspect, the top microtexture projects outwardly from the top surface and defines a positive protrusion, and the bottom microtexture projects inwardly into the bottom surface and defines a negative protrusion.

In one aspect, the decorative component also includes a light source disposed adjacent the body portion for projecting light through the body portion, wherein the light source is controllable automatically in response to sensor signals received at a controller.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 is a perspective view of a microtexture disposed on opposite sides of a clear or translucent decorative component according to an aspect of the disclosure;

FIG. 2A is a schematic illustration of the microtexture on the decorative component, and further illustrating a reflective backing panel and an optional light source;

FIG. 2B is schematic illustration of the lens having a non-planar shape according to an aspect of the disclosure;

FIG. 3 is a front view of the microtexture of FIG. 1 according to an aspect of the disclosure;

FIG. 4A is a top view of the microtexture of FIG. 1 according to an aspect of the disclosure;

FIG. 4B is a bottom view of the microtexture of FIG. 1 according to an aspect of the disclosure;

FIG. 5 is a right side view of the microtexture of FIG. 1 according to an aspect of the disclosure;

FIG. 6 is a perspective view of a microtexture on opposite sides of a lens according to another aspect of the disclosure;

FIG. 7 is a top view of the microtexture of FIG. 6 according to an aspect of the disclosure;

FIG. 8 is a front view of the microtexture of FIG. 6 according to an aspect of the disclosure;

FIG. 9 is a side view of the microtexture of FIG. 6 according to an aspect of the disclosure; and

FIG. 10 is a perspective view of an additional graphical feature disposed on the component in addition to a microtexture according to an aspect of the disclosure.

### DETAILED DESCRIPTION OF THE DISCLOSURE

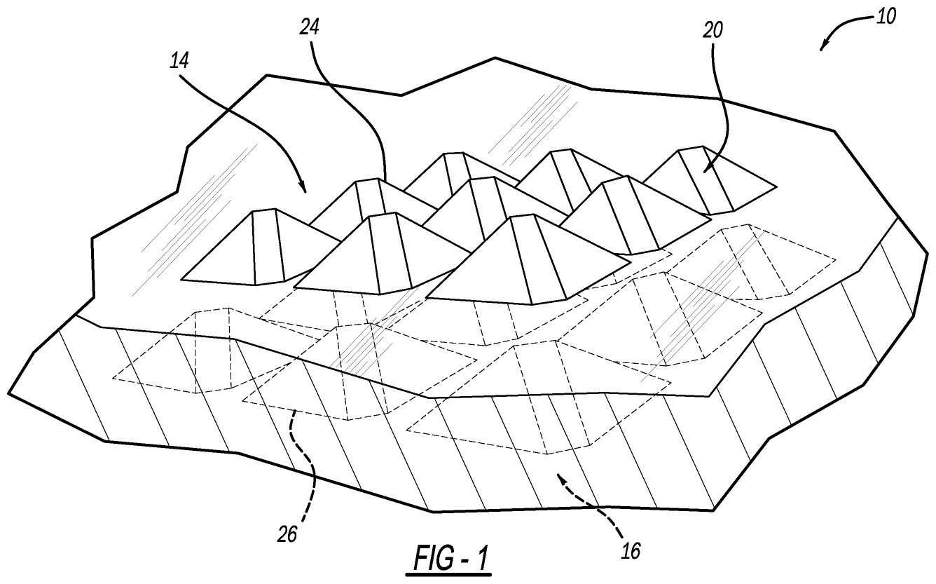

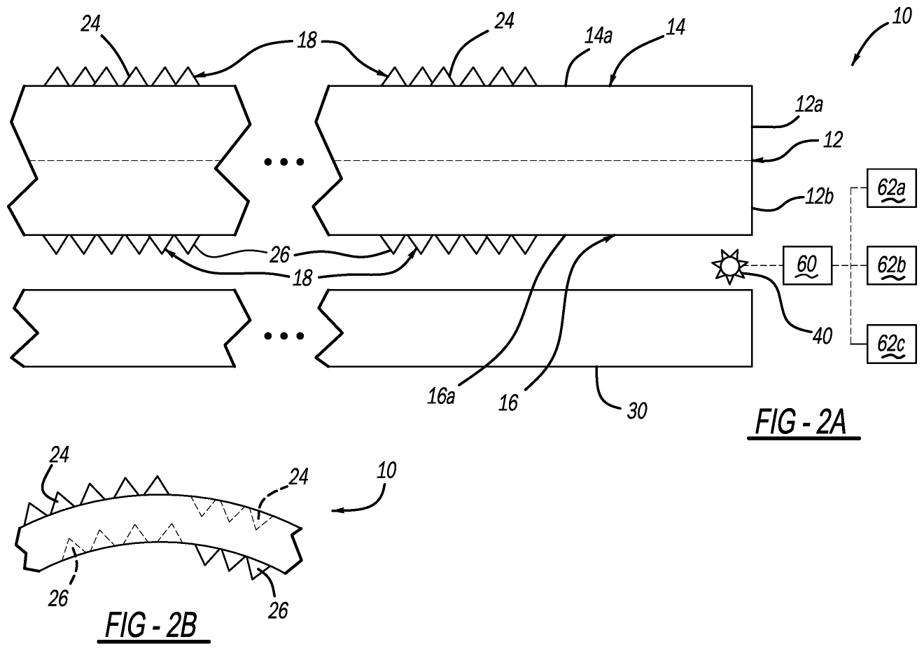

With initial reference to FIGS. 1 and 2A, a decorative component in the form of a clear or translucent panel, trim, or lens is shown. For purposes of discussion, the decorative component will be referred to hereinafter as lens 10, but it will be appreciated that reference to the lens 10 may also be applicable to panels, trim, or other suitable clear or translucent component structure. The lens 10 may include a body 12 having a first side 14 and a second side 16. The first and second sides 14, 16 may also be referred to as first and second surfaces 14, 16, or top surface 14 and bottom surface 16, or front surface 14 and rear surface 16. The first and second sides 14, 16 are disposed on opposite sides of the body 12, and may face opposite directions. The lens 10 may have various overall shapes. As shown in FIGS. 1 and 2, the shape of the lens 10 is in in the form of a rectangular plate. The lens 10 may include microtexture 18 on both the first side 14 and the second side 16. The microtexture 18 on both opposite sides/surfaces 14, 16 of the lens 10 provides for a decorative component with a unique aesthetic appearance with improved depth and increased design options.

The lens 10 may have a variety of other shapes that are not explicitly shown. For example, the lens 10 may have a curved profile, a cup-shape, a convex/concave shape, a circular shape, an ovular shape, or the like. One example of a non-planar shape is shown in FIG. 2B (illustrating a convex and concave shape). The lens 10 may have a variety of flat or planar shapes, such as a disc shape or panel shape, with a variety of perimeter profiles, such as a square, rectangle, or other polygon. The lens 10 may have a varying overall thickness, although as shown the thickness is generally constant. The term opposite is used herein to refer to sides or surfaces through which a vector can pass when passing through the component structure. For example, the opposite sides/surfaces need not be 180 degrees opposed or on opposite parallel planar sides. For example, left and right sides of a triangular cross-section may be considered opposite sides.

The microtexture 18 may be disposed on each of the surfaces 14, 16, as described above. The microtexture 18 may be in the form of an array or series or plurality of protrusions 20, as shown in FIG. 1. FIG. 1 illustrates one 3×3 array of protrusions 20 on the top and bottom surfaces 14, 16, but it will be appreciated that this or other arrays may be repeated multiple times across a surface.

The protrusions 20 may extend outwardly from each of the surfaces 14, 16, or they may extend inwardly into the surfaces 14, 16 in the form of a recess or cavity. Whether extending outwardly in a positive manner or inwardly in a negative manner, the protrusions 20 may extend across the surfaces 14, 16 in a pattern or array to define the overall microtexture 18. It will be appreciated that reference to a “protrusion” refers to both positive and negative protrusions as is not limited to structure that protrudes outwardly from a base or surface, and may also include the instances described herein where a recess or cavity or absence of material protrudes into a material or surface. FIG. 1 illustrates positive protrusions on the top and negative protrusions on the bottom. FIG. 2A illustrates positive protrusions on both sides.

The surfaces 14, 16 may combine with the lens body 12 to define the overall shape and structure of the lens 10. In one aspect, the surfaces 14, 16 are the surfaces of the lens body 12, and the lens body 12 is a single monolithic piece. The lens body 12 may be molded as a single piece with the microtexture 18 along with the body 12. In another aspect, the surfaces 14, 16 may be separate pieces 12a, 12b that make up lens body 12 that are joined together via a positive locking connection, adhesive, bonding, welding, fasteners, or the like. The surfaces 14 and 16, when assembled, may define an interior space therebetween when assembled in this manner, according to one aspect.

With further reference to the form of the lens 10, the lens 10, which may be a clear or translucent panel, trim, or lens as discussed above, may be formed from a plastic resin, glass, or other clear or translucent material.

Each of the surfaces 14 and 16 may define a base surface portion 14a, 16a (see FIG. 2A). The base surface portions 14a, 16a may be generally planar (in the case of a planar shaped lens 10) or may otherwise be generally continuous to define a common surface. The base surface portion 14a, 16a may generally define a “smooth” surface and define the surface from which the protrusions 20 extend outwardly or inwardly, such that the protrusions 20 define a contrast against the generally continuous smooth surface of the of the base surface 14a, 16a. It will be appreciated that other types of base surfaces from which the protrusions 20 extend outwardly or from which the protrusions are recessed may be used, and the base surfaces may be multiple surfaces that are not necessarily completely continuous. Because the lens 10 may have other non-planar shapes, the base surfaces may likewise have non-planar shapes.

The protrusions 20 may be arranged in a desired pattern, series, or array to define the desired appearance or shape. For example, the protrusions 20 may be arranged to define the overall shape of a logo, trade name, symbol, or the like. The protrusions 20 may be arranged such that the spacing between adjacent protrusions 20 used to define the profile of the shape is generally consistent. Put another way, the centers of each of the adjacent protrusions 20 may be evenly spaced.

In another aspect, adjacent protrusions 20 may be unevenly spaced. The protrusions 20 may be distributed in a gradient manner, with the spacing between protrusions increasing in a first direction, decreasing in a first direction, or another similar gradient pattern.

In another aspect, the spacing of the protrusions 20 may be generally random, such that the density of the protrusions may vary, even for the same logo, to create and define a unique representation while also maintaining a commonality for the desired symbol.

In another aspect, the spacing of the protrusions 20 may be in a predetermined pattern with uneven spacing that appears random, but is selected to produce a desired density at different positions within the design.

In one aspect, the protrusions 20 may have a generally symmetrical shape, such as a cone, pyramid, or the like, having equal sides/edges with a central apex. In another aspect, the protrusions 20 may have an apex that is offset from a center of the base of the protrusion, such that the sides and edges leading up to the apex may have uneven lengths, making the appearance of the protrusions 20 different depending on the viewing angle.

In one aspect, the protrusions 20 may all be pointed in the same direction. In another aspect, the protrusions 20 may be pointed in difference directions. Thus, even with consistent spacing, the altered orientation of the protrusions 20 may create a different appearance for some portions of the microtexture 18 relative to others.

In one aspect, the protrusions 20 may have a base profile that gradually transitions to a single apex. The transition may be at a constant slope, or the transitions may be curved to create a convex or concave outer surface that transitions to the apex. In another aspect, the protrusions 20 may have multiple apices, with flat sides or curved sides transitioning from the base to the apices.

In another aspect, the protrusions 20 may have a base profile and an upper profile differing from the base profile. The upper profile may have the same shape but smaller. The upper profile may have a different shape that the bottom profile in another aspect. In one aspect, the upper profile may be the same as the lower profile. In one aspect, the upper profile may be rotated relative to the lower profile.

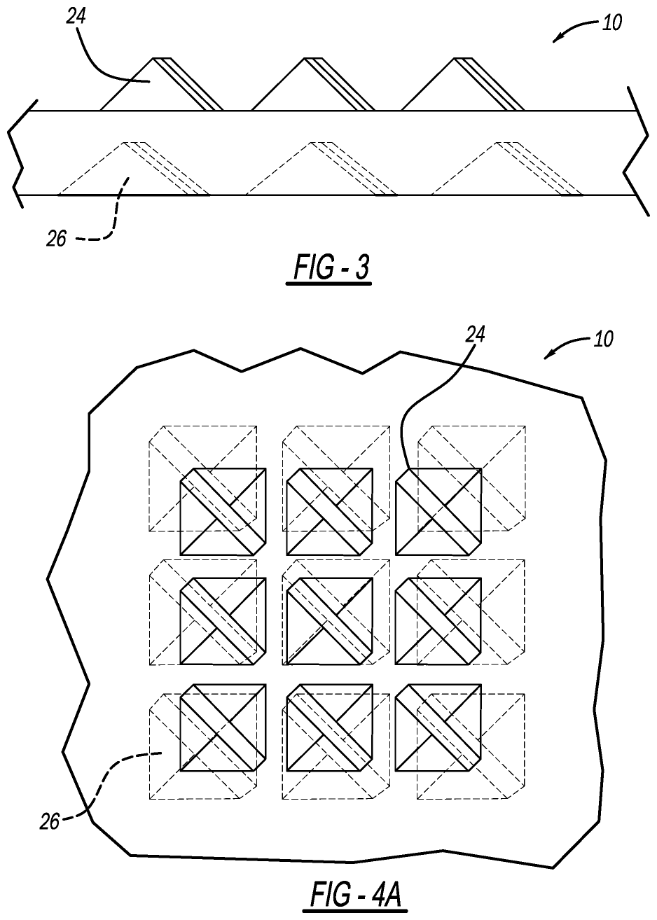

It will be appreciated that various other shapes and styles of protrusions 20 may be used that are not explicitly described herein. The spacing of protrusions across the surfaces 14, 16 may operate to create the desired effect by utilizing a variety of similar or different shapes. For the purposes of further disclosure, the shapes of the protrusions 20 will be described with reference to the generally pyramid-like shape shown in the figures. As shown in FIG. 3 for example, select edges of the pyramid shape are sharp, while other edges include a flat surface at the edge intersection. These sharp of flat edges may be applied to various edges of the various shapes used for the protrusions 20.

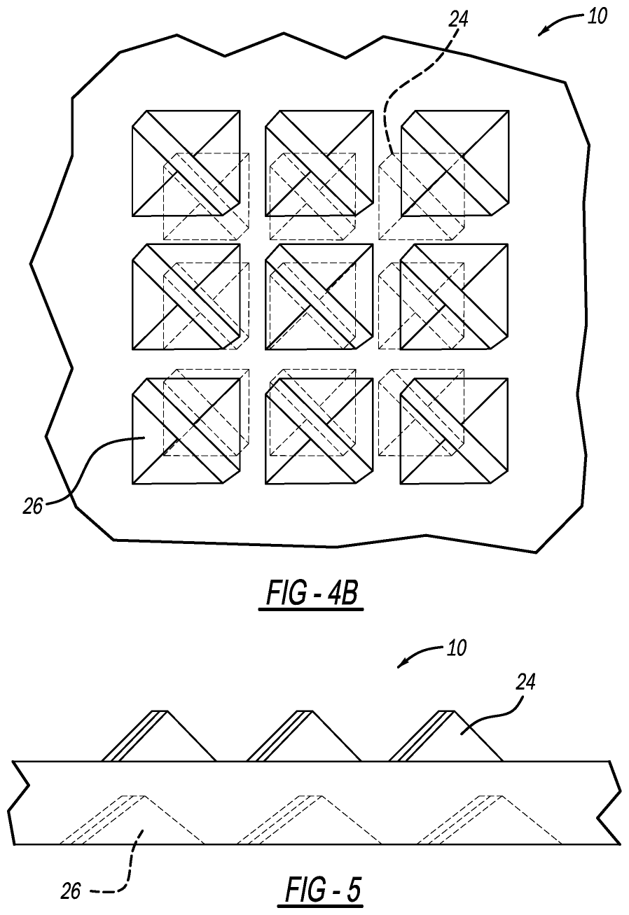

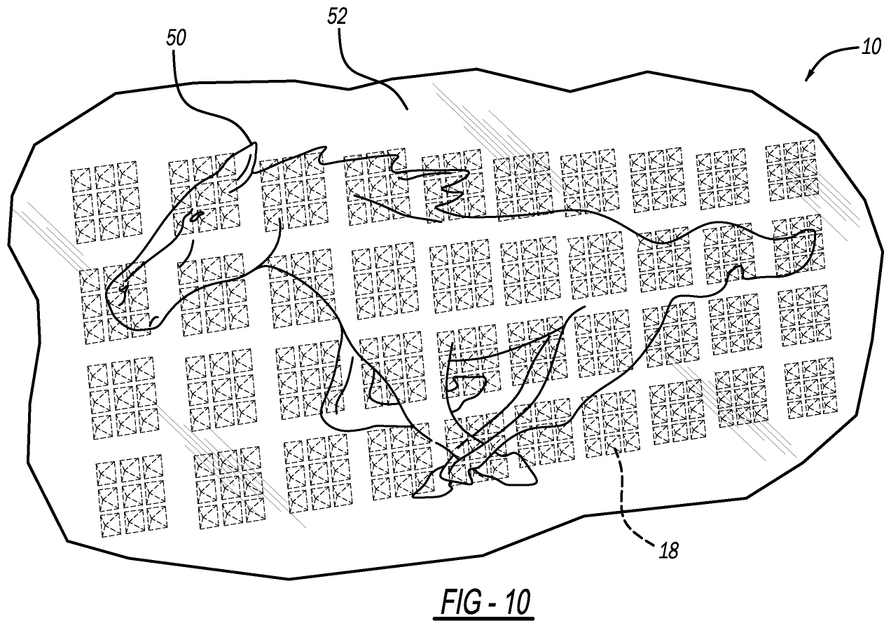

As shown in FIG. 4, an exemplary layout of a plurality of protrusions 20 is shown from above. Additional views of this layout are shown in FIG. 1 (perspective), FIG. 3 (Front), and FIG. 5 (Side). In this exemplary layout, an array of evenly spaced protrusions 20 are arranged in a 3×3 pattern that generally defines the overall shape of a square. Put another way, nine (9) protrusions 20 are arranged in generally constantly spaced pattern. It will be appreciated that other shapes, layouts and arrays may be used to define other shapes. The particular array shown in FIGS. 1 and 3-5 may be repeated across a larger surface area, or may itself be spaced apart from similar arrays (for example as shown in FIG. 10). For example, the grouped array of protrusions 20 may itself be arrayed with other grouped arrays.

As described above, and shown in FIGS. 1-5, the protrusions 20 may be disposed on both the top surface 14 and the bottom surface 16. Accordingly, the plurality of protrusions 20 disposed around the lens 10 may include top protrusions 24 that are part of the top surface 24 and bottom protrusions 26 that are part of the bottom surface 16.

As shown in FIGS. 3-5, the top protrusions 14 are overlaid at least partially over the bottom protrusions 26. The top protrusion 24 in the middle of the pattern (see FIGS. 4A-4B) is overlaid completely over the corresponding bottom protrusion 26. The top protrusions 24 that surround the top protrusion 24 in the middle partially overlay the corresponding bottom protrusions 26. For example, in the lower right corner of FIG. 3, the top protrusion 24 is laid above the corresponding bottom protrusion 26 at the upper left corner of the bottom protrusion 26, with a portion over the top protrusions 24 overlaying an area without a protrusion (such as between adjacent protrusions 26). Other surrounding top protrusions 24 similarly cover a portion of the corresponding bottom protrusions 26, leaving another portion of the corresponding bottom protrusion 26 uncovered when viewed from the top.

As shown in FIGS. 4A-4B, the shape of the top and bottom arrays is generally the same (3×3 square), but the size of each of the top protrusions 24 is smaller than the size of each of the bottom protrusions 26, and therefore the overall size of the array is smaller, and the partial overlap occurs between the protrusions of the top and bottom array. In one aspect, other protrusions in a corresponding array may be aligned to be the “baseline” overlapping pair of top and bottom protrusions 24, 26, rather than the center protrusion shown in FIGS. 4A and 4B. For example, the upper right, lower left, etc. pairs may have a complete overlap, with partial overlaps (or no overlap) occurring for other corresponding pairs. For example, if the lower left pair is aligned, the upper right pair may not overlap at all, depending on relative size and spacing of the protrusions.

The arrangement shown in FIGS. 3-5 may be considered to be “aligned,” where a corresponding number of top protrusions 24 are overlaid over a corresponding number of bottom protrusions 26, even if the overlapping amount of the protrusions 24 and 26 varies. In another aspect, the top protrusions 24 and bottom protrusions 26 may be misaligned, with quantities that do not correspond or with arrangements where there is no overlap. For example, there may be six top protrusions 24 and nine bottom protrusions 26.

With reference to the middle top protrusion 24 and the middle bottom protrusion 26, these middle protrusions 24, 26 may each define the center of the pattern or array that defines the designed graphical representation. For example, the middle top and bottom protrusions 24, 26 may be aligned and overlaid at a location near the middle of the graphic or the pattern.

The different degree of overlap between the top protrusions 24 and the bottom protrusions 26 is a result of different spacing between the top protrusions 24 relative to the bottom protrusions 26. As shown in FIG. 1, the top protrusions 24 are closer together than the bottom protrusions 26. Put another way, the top protrusions 24 are more densely distributed, and the bottom protrusions 26 are less densely distributed. Spacing between adjacent protrusions may be the same and still considered more densely distributed due to the smaller size. In another aspect, similar sized protrusions may have different spacing to increase density. Smaller protrusions may be spaced further apart relative to larger protrusions, thereby having a lesser density, but with increased overlap or alignment. For example, the center of each pair of protrusions 24, 26 may be generally aligned, but with different sizes and therefore different spacing therebetween.

It will be appreciated that the array of protrusions 24, 26 shown in FIG. 1 may be a portion of a larger array that continues to be distributed outwardly according to the same/similar spacing. For example, a 5×5 pattern may be arranged in a similar manner. Other patterns and arrays may also be used. However, in another aspect, the 3×3 pattern may be duplicated and reproduced as a unit or a larger array, such that multiple 3×3 patterns (or other given patterns) may be distributed across a surface, such as in FIG. 10.

The top protrusions 24 and the bottom protrusions 26 may be arranged relative to each other to define a center or prime overlapping point, where at least one of the top protrusions 24 is aligned with a corresponding bottom protrusion 26. As shown, this center or prime overlapping point is located at the middle protrusions 24 and 26 of the illustrated patterns. However, the prime overlapping point could be any of the pairs of corresponding protrusions 24, 26, with the top or bottom patterns being shifted to align a different pair of protrusions.

As shown in FIGS. 3-5, the bottom protrusions 26 are spaced apart more than the spacing of the top protrusions. In another aspect, the bottom protrusions 26 may be spaced apart closer than the top protrusions 24. In this aspect, the bottom protrusions 26 may be bunched together more closely, such that partial overlaps between the top protrusions 24 and bottom protrusions 26 may still occur.

As shown in FIGS. 3-5, the bottom protrusions 26 are larger than the top protrusions 24. Accordingly, for the middle protrusions 24, 26 that are aligned, the top protrusion 24 is completely overlapped by the bottom protrusions 26, but the bottom protrusions 26 is not completely overlapped by the top protrusions 24. In this aspect, the bottom protrusions 26 at the prime overlapping point is still at least partially visible through the lens 10 when viewed from above. It will be appreciated that reference to a protrusion being visible is not intended to indicated that a particular protrusion or other portion thereof is completely blocked, as light may reach various protrusions from a variety of angles.

In another aspect, the bottom protrusions 26 may be the same size and shape as the top protrusions 24. In this aspect, the top protrusions 24 and the bottom protrusion 26 may both be completely overlapped in the area of the prime overlapping point. When the spacing is the same, each of the bottom protrusions 26 may be fully overlapped by the corresponding top protrusion 24, and vice versa.

In another aspect, the bottom protrusions 26 may be smaller than the top protrusions 24. In this aspect, the bottom protrusion 26 may be completely covered by the top protrusions 24 at the location of the prime overlapping point.

In one aspect, the larger protrusions, such as the bottom protrusions 26 shown in FIG. 3, may be spaced apart more than the smaller protrusions, such as the top protrusions 24 shown in FIG. 3. In another aspect, the top protrusions 24 and the bottom protrusions 26 may be spaced apart from each other such that the gap between the bases of the protrusions may be the same, such as the example shown in FIG. 3. However, due to the larger size of the protrusions, such as the bottom protrusions 26 shown in FIG. 3, the overall space taken up by the pattern of bottom protrusions 26 is greater.

In another aspect, the spacing between the larger protrusions, such as the protrusions 26 shown in FIG. 3, may be smaller than the spacing between the smaller protrusions, such as the protrusions 24 shown in FIG. 3. In this aspect, the pattern of the top protrusions 24 may take up a similar space to the pattern of the bottom protrusions 26, even when the bottom protrusions 26 are larger.

In one aspect, the heights of the protrusions 24, 26 may be approximately the same, with the size of the base defining the overall size. FIG. 3 illustrates the top protrusions 24 being approximately the same height as the bottom protrusions 26, but the pattern of bottom protrusions 26 takes up more space because the bases are larger. However, in another aspect, the heights of the protrusions 24, 26 may be different. In one aspect, the bottom protrusions 26 may have a larger base and smaller height relative to the top protrusions 24 (or vice versa). In another aspect, the smaller protrusions may have the same relative sizing, such that the smaller protrusions are scaled down relative to the larger protrusions.

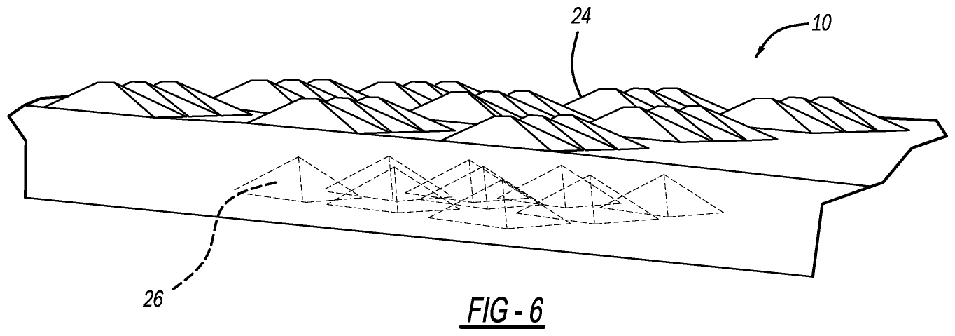

An example of different sizing and spacing of protrusions is illustrated in another aspect shown in FIGS. 6-9. As shown in this aspect, the top protrusions 24 and bottom protrusions 26 may be arranged such that they do not align. In this aspect, the shapes of the top protrusions 24 are different from the shapes of the bottom protrusions 26. Moreover, the array of the top protrusions 24 includes three rows of grouped arrays, with each of the grouped arrays having three protrusions 24. Thus, there are nine protrusions (three groups of three) in the first, second, and third row. The grouping and spacing of the top protrusions 24 still creates a 3×3 array, but the array is of groups of three, rather than a 3×3 array of single protrusions, which is what is used for the bottom protrusions 26 in this aspect. The arrangement of FIGS. 6-9 is described further below. It will be appreciated that this arrangement is but one alternative arrangement and that other arrays and spacing may also be used in accordance with the aspects provided in the present disclosure.

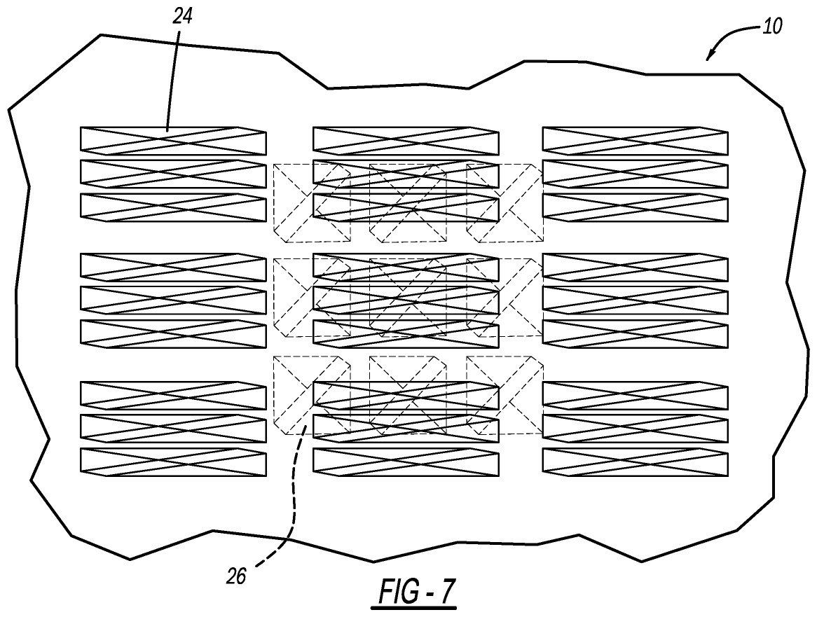

Thus, as shown in FIG. 7, the top protrusions 24 have generally thin rectangular base shapes, and the bottom protrusions 26 have a square-type base similar to those of FIGS. 1 and 3-5.

As shown in FIG. 7, a group of top protrusions 24 may be bunched together to define a sub-pattern or sub-group of top protrusions 24. In the example shown in FIG. 7, the sub-group includes three top protrusions 24 bunched together, and the illustrated pattern includes nine sub-groups. Accordingly, the design may appear from some views/angles/distances to have nine features in the pattern, and from other views/angles, such as a closer view, the individual top protrusions 24 that make up the sub-group may be visible, such that twenty-seven (27) top protrusions 24 are visible (in the example of FIGS. 6-9).

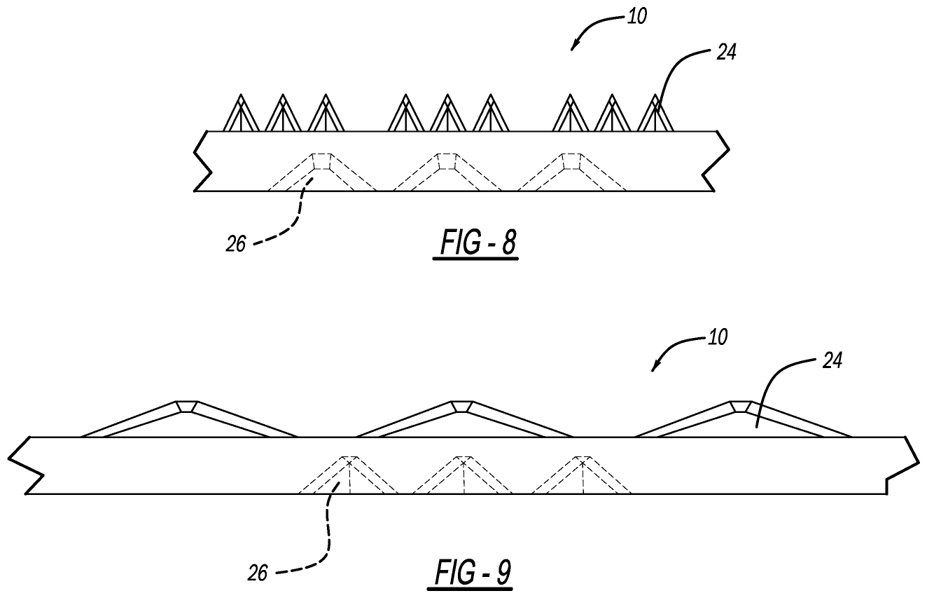

As shown in FIG. 7, the center sub-group of top protrusions 24 is generally aligned with the central bottom protrusion 26, with additional sub-groups of protrusions 24 disposed outward from the central group of top protrusions 24, and additional single bottom protrusions 26 disposed outward from the central bottom protrusions 26. As shown in FIGS. 8 and 9, the bottom protrusions 26 have approximately the same height as the top protrusions 24, but are substantially wider when viewed from the front in FIG. 8, and substantially shorter when viewed from the side in FIG. 9. However, in FIG. 8, the overall with of each sub-group of top protrusions 24 is approximately the same (slightly larger as shown) as the width of a single bottom protrusion 26. In this aspect, the center sub-group of top protrusions 24 may be interpreted as overlapping the center bottom protrusion 26.

In the arrangement shown in FIG. 7, some of the top protrusions 24 (the protrusions 24 in the top and bottom rows) are arranged such that they do no overlap any bottom protrusions 26. However, in another aspect, additional bottom protrusions 26 may be provided and the pattern may extend outward such that the outer-most top protrusions 24 at least partially overlap one or more bottom protrusions 26. Alternatively, the pattern of the top protrusions 24 may be altered such that the top protrusions 24 of the illustrated example overlap the bottom protrusions 26. In another aspect, the illustrated spacing of the top protrusions 24 and bottom protrusions 26 may be considered as a sub-unit, and the entire sub-unit, including the non-overlapping protrusions, may itself be arrayed across a surface.

In one aspect, the protrusions 20 (whether top or bottom) may be provided positively or negatively in the material of the lens body 12. When the protrusion 20 is provided positively, material of the lens 10 extends outward from the surface of the lens body 12. When the protrusion is provided negatively, the shape of the protrusion is “removed” below the surface of the lens body 12. Put another way, the protrusion 20 is in the form of a recess or cavity in the surface when it is negative. Reference to removed need not require actual removal of material, as such a recess or cavity may be defined by a projection in a mold or the like.

The pattern of protrusions 20 across the top surface 14 or bottom surface 16 may be the same type (positive/negative), or may change at different locations on the surface to define the microtexture 18. For example, on the top surface 14, all of the protrusions 24 may be positive and may therefore be in the form of material that projects outwardly from the surface 14. On the bottom surface 16, all of the protrusions 26 may be negative, and the cavity or recess defined by the protrusions will extend or project inwardly into the bottom surface 16 to define a pattern of recesses of cavities that are shaped as desired. Examples of such an arrangement are shown in FIGS. 1, 3-5, and 6-9.

In another aspect, on the top surface 14, some of the protrusions 24 may be positive, and some of the protrusions 24 may be negative. Similarly, the bottom surface 16 may have both positive and negative protrusions 26. In the case of both positive and negative protrusions, the resulting microtextured surface may still provide for the desired graphical representation. It will be appreciated that various positive/negative combinations, both on the same sides and opposite sides of the same decorative component or different decorative components, may be used, along with the variety of shapes and layouts to provide for a virtually endless range of design options.

In one aspect, the top protrusions 24 and bottom protrusions 26 may all be positive. An example of such an arrangement is shown in FIG. 2A. In another aspect, all of the top protrusions 24 and bottom protrusions 26 may be negative. In another aspect, the top protrusions 24 and bottom protrusions 26 may include both the positive and negative form, as illustrated in FIG. 2B.

In the case of negative protrusions 20 being disposed on one of the surfaces of the lens body 12, the depth of the negative protrusions 20 is less than the thickness of the lens body 12. In the case of negative protrusions 20 on both sides of the lens body 12, the combined depth of the protrusions 20 is preferably less than the thickness of the lens body 12, such that overlapping protrusions 20 do not intersect and define a hole extending through the lens body 12, unless a hole or passthrough is desirable. In another aspect, the depth of negative protrusions 20 may be more than half of the thickness, with overlapping negative protrusions 20 being less than half of the thickness, at least in the area of the overlap. For example, pyramids may be slightly offset and each be more than half the thickness of the lens body 12 without the protrusions 20 intersecting each other. In another aspect, the alignment of the negative protrusions 20 on both sides of the lens body 12 is such that they do not overlap, and in such case the depth of the negative protrusions 20 may be increased.

In one aspect, the lens 10 is a single solid piece of material, with the microtexture 18 on the top surface 14 and bottom surface 16 provided via a molding process. A mold may be provided that includes the opposite of the feature to be created on the respective surface. For example, if the top surface 14 includes top protrusions 24 that are all positive, then the mold may include a plurality of recesses or cavities on the side of the mold that creates the top surface 14. The opposite arrangement may be used to define negative protrusions 20. The material of the lens may be a clear or translucent plastic resin or other clear or translucent material. In one aspect the lens 10 may be formed of glass. In one aspect, the lens 10 may be machined or etched from a blank to define the microtexture 18.

In another aspect, the top surface 14 and the bottom surface 16 may be separate pieces that are joined together. In one aspect, a layer of material may define the top surface 14 and may include projections or recesses to define the positive or negative top protrusions 24. Similarly, a layer of material may be used for the bottom surface, with recesses or projections extending from the bottom surface 16 to define the bottom protrusions 26. In this aspect, the thickness of the material of each side is preferably greater than the maximum depth of any recesses that are used to define the microtexture 18 on each particular side. The thicknesses of the surfaces 14 and 16 can be the same, or they can be different. The inner surfaces of each of the pieces may be substantially flat, planar, or correspondingly curved (convex+concave) such that the pieces may mate together.

In another aspect, the top and bottom surfaces 14 and 16 may be separate pieces, and may have a generally constant thickness. Accordingly, a positive or negative protrusion 20 may have a corresponding opposite shape on the opposite side of the surface 14, 16. In this aspect, the top surface 14 and the bottom surface 16 may be joined together and may include a spacer material or the like inserted therebetween, to account for negative protrusions that project inwardly.

The lens 10 may function to provide the graphical representation using only ambient light, such that daylight or lights provided separate from the lens 10 (such as headlights of other vehicles or environmental lights sources), may shine through the lens 10 and may create the graphical representation having the desired depth and appearance that is provided by the microtexture on both surfaces 14, 16 of the lens 10.

Accordingly, the microtexture 18 described herein may provide for this enhanced aesthetic feature with various types of light being provided from the exterior of the vehicle. However, additional light sources, including light sources dedicated to the lens or intended for use to illuminate the lens and the graphical feature may also be provided.

In one aspect, the lens 10 may be provided along with a reflective backing panel 30, as illustrated in FIG. 2A. The reflective backing panel 30 may have a shape that corresponds to the shape of the lens 10, or the panel 30 may have a different shape. In one aspect, the reflective panel 30 may have a shape that corresponds to the overall profile of the graphical feature that is created by the microtexture 18. The reflective panel 30 may be made of metal, plated plastic, PVD coated plastic, or the like. The reflective panel 30 may be used with a lens 10 having no additional or dedicated light source, and the reflective panel 30 may also be used along with a lens 10 and an associated light source.

In one aspect, the lens 10 include a light source 40. The light source 40 may be disposed between the lens 10 and the reflective panel 30. Alternatively, the light source 40 may be disposed at the side of the lens 10. The light source 40 may be an LED or the like, and may be configured to transmit light through the lens 10 to illuminate the graphical feature defined by the microtexture 18. When activated, the light from the light source 40 may reflect off of the reflective panel and propagate through the light transmissive material of the lens 10, such that the features of the microtexture 18 become illuminated and accentuated.

The light source 40 may be in the form of a static illumination or it may include dynamic illumination. For example, the light source 40 may be activated and may provide a single fixed intensity illumination. Alternatively, the light source 40 may have multiple illumination modes, such that the light source may illuminate different colors, and may include a pulsed or flashing illumination feature. The use of the light source 40 may be beneficial for activating or illuminating the microtexture 18 and the resulting graphical representation in situations where ambient light is limited.

In one aspect, the light source 40 may be activated and/or adjusted automatically by a controller in response to detected conditions, such as a vehicle controller detecting vehicle or environment states. For example, the light source 40 may be activated or adjusted based on vehicle speed, driving mode, or ambient light. For example, when dark, the light source 40 may be activated automatically. In another example, lighting of the lens 10 may activated by vehicle braking. The lens 10 may be illuminated in accordance with other vehicle lighting, such as normal use headlights, high beams, interior lights, brake lights, reverse lights, etc.

In another aspect, the light source 40 may be activated and/or adjusted based on inputs by a user/operator, such as a vehicle driver or passenger in the case of a vehicle. For example, in response to a desire to activate the decorative component, the driver may turn on the feature, but may turn it off even in dark conditions if desired.

In one aspect, the light source 40 may be multiple light sources, which may each be activated independently to activate or intensify selected portions of the lens 10. For example, light sources 40 may be positioned at a central location as well as surrounding locations, and the central light source 40 could be activated separate from the surrounding light sources to selectively illuminate surrounding decorative features, patterns, logos, or the like.

With reference to FIG. 2A, a controller 60 is shown in operative communication with the light source 40, which may be interpreted to represent multiple light sources 40. The controller 60 is shown in operative communication with a plurality of sensors 62a, 62b, 62c, etc., which may be interpreted to represent any number of sensors configured to detect various vehicle conditions, such as speed, braking, ambient light, manual user activation, and/or the like.

In another aspect, an additional graphic design 50 may be included along with the design or pattern provided by the microtexture 18. For example, a logo related to the vehicle or the graphical design of the microtexture may be included on the lens 10. This additional graphic design may be referred to as a printed feature 50, to distinguish this design from the shape or design created by the microtexture 18. For example, the microtexture 18 may define a shape having a border that defines the profile of a logo, other design, or the like. The printed feature may correspond to that shape of the microtexture or may complement the shape of the microtexture. It will be appreciated that the printed feature 50 can be provided in different manners and not necessarily via a printing method. The printed feature 50 may be etched, molded, or the like.

In one aspect, the printed feature 50 may be applied to an exterior surface of the lens 10. In another aspect, the printed feature 50 may be applied to an interior surface of the lens 10. Because the lens 10 is generally transparent or translucent (light transmissive), the printed feature 50 may be viewable through the lens 10, even when provided on the interior surface of the lens 10.

According to still another aspect of the disclosure, the lens 10 may include a coating 52 over the exterior surface. The coating 52 may provide a variety of different appearances. For example, it may be clear or tinted. It will also be appreciated that the coating 52 can serve a variety of purposes, including for decoration, uv protection, weathering protection, and mar and wear resistance. It will be appreciated that the coating 52 may be a topcoat. In one aspect, the coating 52 is a hardcoat. The coating 52 may alternatively be placed on the interior surface of the lens. It will further be appreciated that the coating 52 can have a variety of different appearances and colors and can served a variety of different purposes. The printed feature 50 may be provided with shading or the like to make the printed feature appear to be projecting from the surface or recessed in the surface of the lens 10.

The printed feature 50 may be provided at a uniform depth, or the printed feature 50 may be provided at multiple depths within the lens 10 to add further complexity if desired by the designer. In another aspect, a laser, such as a femtosecond laser, may be used with the lens 10 to generate a molded texture or graphic design that incorporates color into the design. FIG. 10 illustrates one example of the printed feature 50 that is disposed on the lens 10, along with the microtexture 18 and protrusions 20 previously described. it will be appreciated that the printed feature 50 illustrated in FIG. 10 represents the various types and positions of the printed feature 50 described herein, such as projected structure, recessed structure, printed graphics, etching, topcoats, etc. on either the top surface, bottom surface, or within the lens 10.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A decorative component for use with an automotive vehicle, the decorative component comprising:
a lens body defining a first surface and a second surface, wherein the first surface and the second surface are disposed on opposite sides of the lens body;
a plurality of first protrusions disposed on the first surface;
a plurality of second protrusions disposed on the second surface;
wherein the first and second protrusions define a first and second microtexture on the first and second surface, respectively;
wherein the first and second microtextures combine to define a graphical representation on the lens having an enhanced depth and blending of the microtextures.

2. The decorative component of claim 1, wherein the first protrusions are arranged in a first pattern on the first surface and the second protrusions are arranged in a second pattern on the second surface.

3. The decorative component of claim 2, wherein the first protrusions are spaced apart a first distance and the second protrusions are spaced apart a second distance that is different than the first distance.

4. The decorative component of claim 2, wherein the first and second pattern are different.

5. The decorative component of claim 1, wherein the first protrusions are positive and project from the first surface, and the second protrusions are negative and define recesses in the second surface.

6. The decorative component of claim 2, wherein at least one of the first protrusions overlies at least one of the second protrusions.

7. The decorative component of claim 1, wherein the lens is a single piece, and the first and second surfaces are defined on the single piece.

8. The decorative component of claim 1, further comprising a reflective panel disposed adjacent the second surface of the lens.

9. The decorative component of claim 8, further comprising a light source disposed between the lens body and the reflective panel.

10. The decorative component of claim 1, further comprising a printed feature disposed on the lens body in addition to the microtexture.

11. The decorative component of claim 1, wherein the second protrusions are larger than the first protrusions.

12. The decorative component of claim 1, wherein the lens body includes a first piece and second piece, wherein the first surface and first protrusions are disposed on the first piece, and the second surface and the second protrusions are disposed on the second piece, wherein the first piece is attached to the second piece.

13. The decorative component of claim 1, further comprising a coating disposed on at least one of the first surface and the second surface.

14. The decorative component of claim 13, wherein the coating is a protective hardcoat.

15. The decorative component of claim 13, wherein the coating is clear or tinted.

16. A decorative component for use in automotive applications, the decorative component comprising:
a clear or translucent body portion having a first surface and a second surface, wherein the body portion is colored or tinted;
a first microtexture disposed on the first surface;
a second microtexture disposed on the second surface;
wherein the first and second microtextures combine to define a graphical representation having an enhanced depth and blending of the microtextures.

17. The decorative component of claim 16 further comprising a light source disposed adjacent the body portion for transmitting light through the body portion and illuminating the microtextures, and a reflective surface disposed adjacent the second surface, wherein the reflective surface reflects ambient light or light provided by a light source through the lens body and the first and second microtextures.

18. A decorative component for an automobile, the decorative component comprising:
a clear or translucent body portion having a top surface and a bottom surface, wherein the body portion is colored or tinted;
a top microtexture disposed on the top surface;
a bottom microtexture disposed on the bottom surface;
wherein light passing through the body portion reflects off the top and bottom microtextures and defines a graphical representation.

19. The decorative component of claim 18, wherein the top microtexture projects outwardly from the top surface and defines a positive protrusion, and the bottom microtexture projects inwardly into the bottom surface and defines a negative protrusion.

20. The decorative component of claim 19 further comprising a light source disposed adjacent the body portion for projecting light through the body portion, wherein the light source is controllable automatically in response to sensor signals received at a controller.
